(19) United States
(12) Patent Application Publication
(10) Pub. No.: US 2018/0106330 A1
(43) Pub. Date: Apr. 19, 2018

(54) Power Transmission Apparatus for Vehicle

(71) Applicant: Hyundai Motor Company, Seoul (KR)

(72) Inventors: Yeo Hyeon Gwon, Yongin-si (KR); Hyun Chul Kim, Suwon-si (KR); Hyojung Ryu, Ulsan (KR); Jong Min Kim, Hwaseong-si (KR); Minwook Lee, Osan-si (KR)

(21) Appl. No.: 15/377,792

(22) Filed: Dec. 13, 2016

(30) Foreign Application Priority Data
Oct. 13, 2016 (KR) 10-2016-0132968

(51) Int. Cl. F16H 3/085; F16H 3/00; F16H 37/08

(52) U.S. Cl. CPC F16H 3/085; F16H 2200/006; F16H 37/0806; F16H 3/006

(57) ABSTRACT

A power transmission apparatus for a vehicle includes a power control unit constituted by first and second clutches. An input unit is configured by configuring a number of input gears on first and second input shafts overlapped and disposed on the same axis line without rotary interference so that the rotary power of the engine is input through the power control unit. A shift output unit is constituted by first and second output shafts which are disposed in parallel to the first and second input shafts, respectively. A number of synchronization units synchronization-connect the plurality of transmission gears to the first and second output shafts. A reverse shift unit is constituted by a reverse input gear configured in one input shaft of the first and second input shafts, and a reverse transmission gear disposed on an output shaft and synchronization-connected to output shaft by the synchronization unit.

### CROSS-REFERENCE TO RELATED APPLICATIONS

This application claims priority to and the benefit of Korean Patent Application No. 10-2016-0132968 filed in the Korean Intellectual Property Office on Oct. 13, 2016, the entire contents of which are incorporated herein by reference.

### TECHNICAL FIELD

The present invention relates to a power transmission apparatus for a vehicle.

### BACKGROUND

An environmentally friendly technology in a vehicle is a core technology that influences survival of a future car industry and car makers have devoted all their energy to the development of an environmentally friendly car for meeting environmental and fuel efficiency regulations.

The future car technology may include an electric vehicle (EV) using electric energy, a hybrid electric vehicle (HEV), and a double clutch transmission (DCT) improving efficiency and convenience as an example.

In the above description, the DCT related with the present invention includes two clutch devices and a gear train of a fundamental manual transmission, and selectively transfers rotary power input from an engine to two input shafts by using two clutches and shifts the rotary power transferred to the input shaft by using the gear train of the manual transmission and thereafter, outputs the shifted rotary power.

The DCT is attempted in order to compactly implement a high-level transmission of 5 levels or more and implemented as an auto manual transmission (AMT) that controls two clutches and synchronization devices by a controller to make manual shifting of a driver be unnecessary.

As a result, since advantages in that power transmission efficiency is excellent as compared with an automatic transmission achieved by combining planetary gears and components are easily changed and added depending on multiple levels may meet the fuel efficiency regulation and efficiency of the multiple levels, the DCT has further come into the spotlight.

Further, since the DCT is based on a manual transmission having high power transmission efficiency and two clutches alternately operate in the DCT, the DCT has advantages in that the shifting is rapidly performed and ride comfort is smooth.

Meanwhile, as the existing transmission, 6 and 7-level transmissions are primarily used, but in recent years, implementing multiple levels (that is, approximately 8 to 10 levels) of a shift step is a global trend in order to cope with the fuel efficiency regulation of the vehicle, which has become stricter and since the DCT is based on a structure of the manual transmission that independently configures a gear ratio of each step even though the DCT is more excellent than the automatic transmission in efficiency, a whole length and a volume of the transmission increase due to the multiple levels. Therefore, the DCT has a limit in that there is a problem in mountability.

In particular, in the case of a front wheel type DCT, since both the engine and the transmission are configured among frames in an engine room, there is a small limit in volume, but there is a limit in upper whole length.

The above information disclosed in this Background section is only for enhancement of understanding of the background of the invention and therefore it may contain information that does not form the prior art that is already known in this country to a person of ordinary skill in the art.

The above information disclosed in this Background section is only for enhancement of understanding of the background of the invention and therefore it may contain information that does not form the prior art that is already known in this country to a person of ordinary skill in the art.

### SUMMARY

The present invention relates to a power transmission apparatus for a vehicle, and in particular embodiments, to a power transmission apparatus for a vehicle, which a reverse shift is achieved by additionally arranging a pair of gears on an input shaft and an output shaft of a double clutch transmission to prevent an upper whole length of a transmission from being increased.

The present invention has been made in an effort to provide a power transmission apparatus for a vehicle which prevents an upper whole length from being increased by additionally disposing a pair of gears for reverse shifting on an input shaft and an output shaft of a double clutch transmission to secure mountability.

An exemplary embodiment of the present invention provides a power transmission apparatus for a vehicle. A power control unit is constituted by first and second clutches configured at an output side of an engine to control rotary power of the engine. An input unit is configured by configuring a plurality of input gears on first and second input shafts overlapped and disposed on the same axis line without rotary interference so that the rotary power of the engine is input through the power control unit. A shift output unit is constituted by first and second output shafts which are disposed in parallel to the first and second input shafts, respectively and in which a plurality of transmission gears externally engaging with respective input gears on the first and second input shafts is disposed, a plurality of synchronization units synchronization-connecting the plurality of transmission gears to the first and second output shafts, and first and second output gears configured on the first and second output shafts, respectively to externally engage with a final reduction gear of a differential. A reverse shift unit is constituted by a reverse input gear configured in one input shaft of the first and second input shafts, a reverse transmission gear disposed on one output shaft of the first and second output shafts and synchronization-connected to one output shaft by the synchronization unit, and a reverse idle gear unit disposed on the other output shaft without rotary interference, decelerating and inversely rotating the rotary power of the reverse input gear and transferring the rotary power to the reverse transmission gear to form a reverse shift step power transfer path.

Further, the reverse idle gear unit may include a first reverse idle gear disposed on the other output shaft without rotary interference and externally engaging with the reverse input gear, and a second reverse idle gear disposed on the other output shaft without rotary interference, formed integrally with the first reverse idle gear, and externally engaging with the reverse transmission gear.

The plurality of transmission gears unit may include a first-shift transmission gear to an eighth-shift transmission gear, and the first-shift and six-shift transmission gears are configured in one synchronization unit.

In this case, in the reverse shift step power transfer path, forward rotation power of the engine transferred from the reverse input gear on the one input shaft is decelerated and inversely rotated by the first and second reverse idle gears on the other input shaft to be forward rotated and transferred to the reverse transmission gear synchronization-connected to the one output shaft and inversely rotated and transferred to the final reduction gear of the differential through the output gear on the output shaft to achieve reverse shifting.

According to an exemplary embodiment of the present invention, in a power transmission apparatus having two clutches based on a manual transmission, a pair of gear trains which are externally gear-connected with each other are disposed on an input shaft and two output shafts without a separate idle shaft for a reverse shift to implement a reverse shift step, and as a result, an upper whole length (a circumferential volume) of the transmission is minimized to enhance mountability.

Further, the idle shaft for the reverse shift is omitted, and as a result, an internal configuration can be simplified due to a decrease in the number of components and fuel efficiency can be enhanced by minimizing a weight.

Forward 8 shifts and reverse 1 shift are implemented to enhance the fuel efficiency through implementing multiple levels.

Besides, an effect which can be obtained or predicted by the exemplary embodiment of the present invention is directly or implicitly disclosed in detailed description of the exemplary embodiment of the present invention. That is, various effects predicted according to the exemplary embodiment of the present invention will be disclosed in the detailed description to be described below.

### BRIEF DESCRIPTION OF THE DRAWINGS

FIG. 1 is a configuration diagram of a power transmission apparatus for a vehicle according to an exemplary embodiment of the present invention.

FIG. 2 is a shifting operation table of the power transmission apparatus for a vehicle according to the exemplary embodiment of the present invention.

The following reference symbols can be used in conjunction with the drawings

CL1, CL2 . . . First, second clutch

D1, D2, D3, D4, D5, D6, D7, D8 . . . First, second, third, fourth, fifth, sixth, seventh, and eighth-shift transmission gears

DIFF . . . Differential

FSDG . . . Final reduction gear

G1, G2, G3, G4, G5, G6 . . . First, second, third, fourth, fifth, and sixth input gears

IS1 . . . First input shaft

IS2 . . . Second input shaft

OG1 . . . First output gear

OG2 . . . Second output gear

OS1 . . . First output shaft

OS2 . . . Second output shaft

RG . . . Reverse input gear

R . . . Reverse transmission gear

RIGU . . . Reverse idle gear unit

RIG1, RIG2 . . . First and second reverse idle gears

SL1, SL2, SL3, SL4, SL5 . . . First, second, third, fourth, and fifth synchronizers

### DETAILED DESCRIPTION OF ILLUSTRATIVE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In the following description, dividing names of components into first, second and the like is to divide the names because the names of the components are the same as each other and an order thereof is not particularly limited.

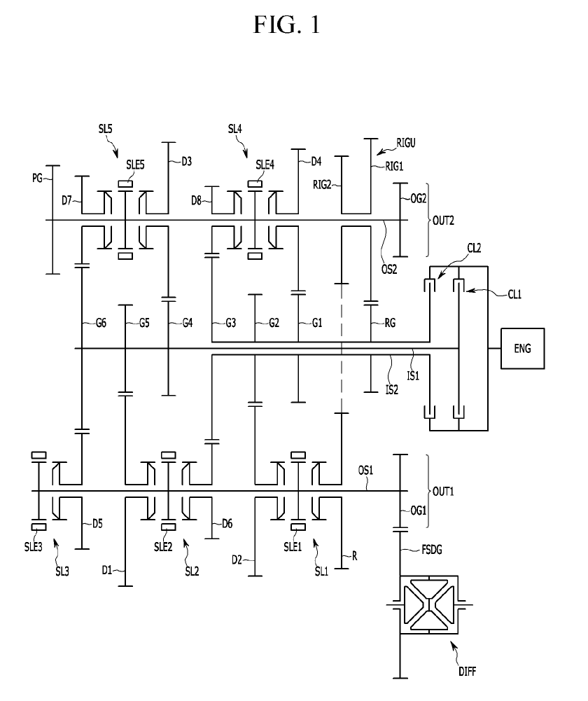

FIG. 1 is a configuration diagram of a power transmission apparatus according to an exemplary embodiment of the present invention.

Referring to FIG. 1, the power transmission apparatus for a vehicle according to the exemplary embodiment of the present invention is configured to include an engine as a power source, a power control unit, an input unit, a shift output unit, and a reverse shift unit.

In the above description, as the engine ENG as the power source, various known engines may be used, which uses fossil fuel such as gasoline, diesel, liquefied gas, and the like.

The power control unit is constituted by first and second clutches CL1 and CL2. Both the first and second clutches CL1 and CL2 are configured between an output side and the input unit of the engine ENG and both the first and second clutches CL1 and CL2 are configured to control rotary power of the engine ENG to selectively transfer the controlled rotary power to the input unit.

Herein, the first and second clutches CL1 and CL2 as hydraulic friction coupling units which are operated by hydraulic pressure supplied from a hydraulic control device primarily adopt a wet multi-disk type hydraulic friction coupling unit, but may be constituted by a coupling unit such as a dry multi-disk clutch which may be operated according to an electric signal supplied from an electronic control device.

The input unit is configured to include first and second input shafts IS1 and IS2 and the first and second input shafts IS1 and IS2 are disposed on the same axis line.

That is, the first input shaft IS1 is configured by a solid shaft and the second input shaft IS2 is configured by a hollow shaft to be disposed on the outer periphery of the first input shaft IS1 without rotary interference.

Herein, a front end of the first input shaft IS1 is selectively connected with the output side of the engine ENG through the first clutch CL1 and the front end of the second input shaft IS2 is selectively connected with the output side of the engine ENG through the second clutch CL2 to receive the rotary power of the engine ENG.

First, second, and third input gears G1, G2, and G3 are sequentially configured on the second input shaft IS2 from a front side to a rear side while being spaced apart from each other and fourth, fifth, and sixth input gears G4, G5, and G6 are configured on the first input shaft IS1, and the fourth, fifth, and sixth input gears G4, G5, and G6 are configured in a rear part of the first input shaft IS1 penetrating the second input shaft IS2 and sequentially configured from the front side to the rear side while being spaced apart from each other.

In the above description, the first, second, third, fourth, fifth, and sixth input gears G1, G2, G3, G4, G5, and G6 are input gears for inputting the rotary power of the engine for each shift step, and the number of gear teeth is set so that the first input gear G1 operates as an input gear for implementing a 4-th shift, the second input gear G2 operates as an input gear for implementing a 2-nd shift, the third second input gear G3 operates as an input gear for implementing 6-th and 8-th shifts, the fourth input gear G4 operates as an input gear for implementing a 3-rd shift, the fifth input gear G5 operates as an input gear for implementing a 1-st shift, and a sixth input gear G6 operates as an input gear for implementing 5-th and 7-th shifts.

Herein, the input gears for implementing odd-numbered shift steps are configured on the first input shaft IS1 and the input gears for implementing even-numbered shift steps are configured on the second input shaft IS2 and the present invention is not limited thereto and the input gears may be configured contrary thereto and the number of input gears is not limited to six and may vary depending on the number of implemented shift steps.

In addition, the shift output unit performs a function to receive the rotary power of the engine ENG from the respective input gears G1, G2, G3, G4, G5, and G6 of the input unit, and shift and output the rotary power.

That is, the shift output unit is constituted by first and second shift output mechanisms OUT1 and OUT2 disposed in parallel with a predetermined interval from the first and second input shafts IS1 and IS2.

The first shift output mechanism OUT1 includes a first output shaft OS1 disposed in parallel with a predetermined interval from the first and second input shafts IS1 and IS2 and a second shift transmission gear D2, first-shift and sixth-shift transmission gears D1 and D6, and a fifth-shift transmission gear D5 are disposed on the first output shaft OS1.

Further, three synchronization units are configured on the first output shaft OS1, and the synchronization unit includes a first synchronizer SL1 selectively synchronization-connecting the second-shift transmissions gear D2 to the first output shaft OS1, a second synchronizer SL2 selectively synchronization-connecting the first-shift or sixth-shift transmission gear D1 or D6 to the first output shaft OS1, and a third synchronizer SL3 selectively synchronization-connecting the fifth-shift transmission gear D5 to the first output shaft OS1.

Herein, the second shift transmissions gear D2 externally engages with the second input gear G2, the first-shift transmission gear D1 externally engages with the fifth input gear G5, the sixth-shift transmission gear D6 externally engages with the third input gear G3, and the fifth-shift transmissions gear D5 externally engages with the sixth input gear G6.

Further, a first output gear OG1 is configured at one side of the front end of the first output shaft OS1 and the first output gear OG1 externally engages with a final reduction gear (FSDG) configured in a known differential DIFF to output the shifted rotary power.

Meanwhile, the second shift output mechanism OUT2 includes a second output shaft OS2 disposed in parallel with a predetermined interval from the first and second input shafts IS1 and IS2 and a fourth-shift and eighth-shift transmission gears D4 and D8 and third-shift and seventh-shift transmission gears D3 and D7 are disposed on the second output shaft OS2.

Further, two synchronization units are configured on the second output shaft OS2 and the synchronization unit includes a fourth synchronizer SL4 selectively synchronization-connecting the fourth-shift or eighth-shift transmission gear D4 or D8 to the second output shaft OS2 and a fifth synchronizer SL5 selectively synchronization-connecting the third-shift or seventh-shift transmission gear D3 or D7 to the second output shaft OS2.

Herein, the fourth-shift transmissions gear D4 externally engages with the first input gear G1, the eighth-shift transmission gear D8 externally engages with the third input gear G3, the third-shift transmission gear D3 externally engages with the fourth input gear G4, and the seventh-shift transmissions gear D7 externally engages with the sixth input gear G6.

Further, a second output gear OG2 is configured at one side of the front end of the second output shaft OS2 and the second output gear OG2 externally engages with the final reduction gear (FSDG) configured in the known differential DIFF to output the shifted rotary power.

In the above description, each of the first-shift and six-shift transmission gears D1 and D6, the fourth-shift and eighth-shift transmission gears D4 and D8, and the third-shift and seventh-shift transmission gears D3 and D7 is configured in one synchronizer, but a preliminary engagement problem which is a unique characteristic of the DCT in which a difference of a shift step is three levels or more does not also occur.

In the above description, since the first, second, third, fourth, and fifth synchronizers SL1 to SL5 are known components, detailed description is omitted and sleeves SLE1, SLE2, SLE3, SLE4, and SLE5 applied to the first, second, third, fourth, and fifth synchronizers SL1 to SL5, respectively include separate actuators (not illustrated) as known and the actuator is controlled by a transmission control unit.

In addition, the reverse shift unit is constituted by a reverse input gear RG configured at one side of the front end on the second input shaft IS2, a reverse transmission gear R disposed on the first output shaft OS1 and synchronization-connected to the first output shaft OS1 by the first synchronizer SL1, and a reverse idle gear unit RIGU disposed on the second output shaft OS2 without rotary interference and decelerating and inversely rotating the rotary power of the reverse input gear RG and transferring the rotary power to the reverse transmission gear R to form a reverse shift step power transfer path.

The reverse idle gear unit (RIGU) is constituted by a first reverse idle gear RIG1 disposed on the second output shaft OS2 without rotary interference and externally engaging with the reverse input gear RG and a second reverse idle gear RIG2 disposed on the second output shaft OS2 without rotary interference and externally engaging with the reverse transmission gear R while being formed integrally with the first reverse idle gear RIG1.

In the reverse shift unit, forward rotation power of the engine ENG transferred from the reverse input gear RG on the second input shaft IS2 is decelerated and inversely rotated by the first and second reverse idle gears RIG1 and RIG2 on the second output shaft OS2 to be forward-rotation transferred to the reverse transmission gear R synchronization-connected to the first output shaft OS1 and inversely rotated and transferred to the final reduction gear (FSDG) of the differential DIFF through the first output gear OG1 on the first output shaft OS1 to form the reverse shift step power transfer path which is shifted reversely.

In FIG. 1, undescribed reference numeral PG represents a parking gear.

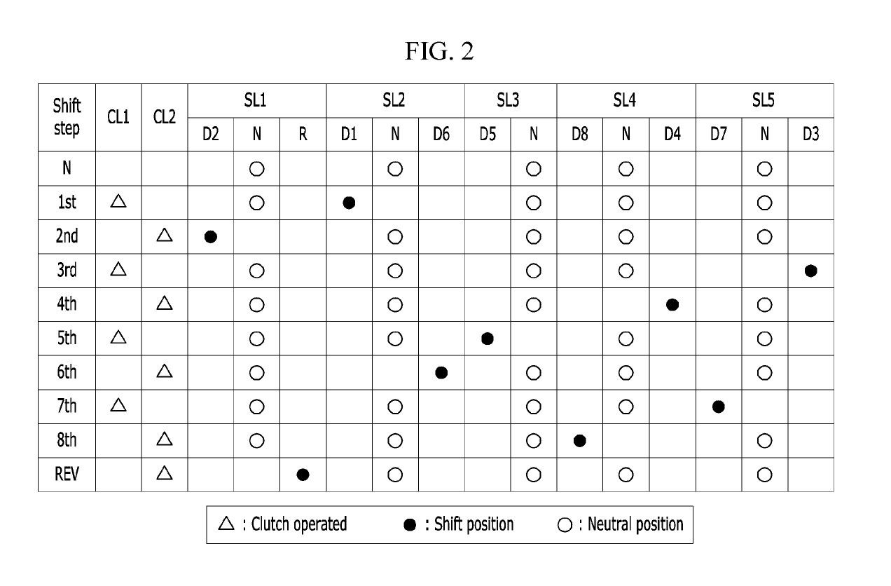

FIG. 2 is a shifting operation table of the power transmission apparatus for a vehicle according to the exemplary embodiment of the present invention and a shifting process will be described below.

### [Forward 1-st Shift]

In the forward 1-st shift, the first-shift transmission gear D1 and the first output shaft OS1 are synchronization-connected through the second sleeve SLE2 of the second synchronizer SL2 and the first clutch CL1 is operation-controlled.

Then, forward 1-st shift driving is performed while the rotary power of the engine ENG is transferred to the final reduction gear FSDG configured in the differential DIFF through the first clutch CL1, the first input shaft IS1, the fifth input gear G5, the first-shift transmission gear D1, the first output shaft OS1, and the first output gear OG1.

In addition, after the forward 1-st shift transmission is completed as described, the second-shift transmission gear D2 and the first output shaft OS1 are synchronization-connected through the first sleeve SLE1 of the first synchronizer SL1 for next forward 2-shift transmission.

### [Forward 2-nd Shift]

When the vehicle velocity increases in the state of the first shift and a driver intends to shift the first shift to the second shift, the second clutch CL2 is operation-controlled and the second sleeve SLE2 of the second synchronizer SL2 is controlled to neutral while the operation of the first clutch CL1 is released in the state of the first shift.

Then, while the second-shift transmission gear D2 and the first output shaft OS1 are synchronization-connected through the first sleeve SLE1 of the first synchronizer SL1 as a preliminary operation of the forward 1-st shift state, the forward 2-nd shift driving is performed while the rotary power of the engine ENG is transferred to the final reduction gear FSDG configured in the differential DIFF through the second clutch CL2, the second input shaft IS2, the second input gear G2, the second-shift transmission gear D2, the first output shaft OS1, and the first output gear OG1.

After the forward 2-shift transmission is completed as described, the third-shift transmission gear D3 and the second output shaft OS2 are synchronization-connected through the fifth sleeve SLE5 of the fifth synchronizer SL5 for next forward 3-rd shift transmission.

### [Forward 3-rd Shift]

When the vehicle velocity increases in the state of the second shift and a driver intends to shift the second shift to the third shift, the first clutch CL1 is operation-controlled and the first sleeve SLE1 of the first synchronizer SL1 is controlled to neutral while the operation of the second clutch CL2 is released in the state of the second shift.

Then, while the third-shift transmission gear D3 and the second output shaft OS2 are synchronization-connected through the fifth sleeve SLE5 of the fifth synchronizer SL5 as the preliminary operation in the forward 2-nd shift state, the forward 3-rd shift driving is performed while the rotary power of the engine ENG is transferred to the final reduction gear FSDG configured in the differential DIFF through the first clutch CL1, the first input shaft IS1, the fourth input gear G4, the third-shift transmission gear D3, the second output shaft OS2, and the second output gear OG2.

In addition, after the forward 3-shift transmission is completed as described, the fourth-shift transmission gear D4 and the second output shaft OS2 are synchronization-connected through the fourth sleeve SLE4 of the fourth synchronizer SL4 for next forward 4-shift transmission.

### [Forward 4-th Shift]

When the vehicle velocity increases in the state of the third shift and the driver intends to shift the third shift to the fourth shift, the second clutch CL2 is operation-controlled and the fifth sleeve SLE5 of the fifth synchronizer SL5 is controlled to neutral while the operation of the first clutch CL1 is released in the state of the third shift.

Then, while the fourth-shift transmission gear D4 and the second output shaft OS2 are synchronization-connected through the fourth sleeve SLE4 of the fourth synchronizer SL4 as the preliminary operation in the forward 3-shift state, the forward 4-th shift driving is performed while the rotary power of the engine ENG is transferred to the final reduction gear FSDG configured in the differential DIFF through the second clutch CL2, the second input shaft IS2, the first input gear G1, the fourth-shift transmission gear D4, the second output shaft OS2, and the second output gear OG2.

In addition, after the forward 4-th shift transmission is completed as described, the fifth-shift transmission gear D5 and the first output shaft OS1 are synchronization-connected through the third sleeve SLE3 of the third synchronizer SL3 for next forward 5-th shift transmission.

### [Forward 5-th Shift]

When the vehicle velocity increases in the state of the fourth shift and the driver intends to shift the fourth shift to the fifth shift, the first clutch CL1 is operation-controlled and the fourth sleeve SLE4 of the fourth synchronizer SL4 is controlled to neutral while the operation of the second clutch CL2 is released in the state of the fourth shift.

Then, while the fifth-shift transmission gear D5 and the first output shaft OS1 are synchronization-connected through the third sleeve SLE3 of the third synchronizer SL3 as the preliminary operation of the forward 4-th shift state, the forward 5-th shift driving is performed while the rotary power of the engine ENG is transferred to the final reduction gear FSDG configured in the differential DIFF through the first clutch CL1, the first input shaft IS1, the sixth input gear G6, the fifth-shift transmission gear D5, the first output shaft OS1, and the first output gear OG1.

In addition, after the forward 5-shift transmission is completed as described, the sixth-shift transmission gear D6 and the first output shaft OS1 are synchronization-connected through the second sleeve SLE2 of the second synchronizer SL2 for next forward 6-shift transmission.

### [Forward 6-th Shift]

When the vehicle velocity increases in the state of the fifth shift and the driver intends to shift the fifth shift to the sixth shift, the second clutch CL2 is operation-controlled and the third sleeve SLE3 of the third synchronizer SL3 is controlled to neutral while the operation of the first clutch CL1 is released in the state of the fifth shift.

Then, while the sixth-shift transmission gear D6 and the first output shaft OS1 are synchronization-connected through the second sleeve SLE2 of the second synchronizer SL2 as the preliminary operation of the forward 5-shift state, the forward 6-shift driving is performed while the rotary power of the engine ENG is transferred to the final reduction gear FSDG configured in the differential DIFF through the second clutch CL2, the second input shaft IS2, the third input gear G3, the sixth-shift transmission gear D6, the first output shaft OS1, and the first output gear OG1.

In addition, after the forward 6-th shift transmission is completed as described, the seventh-shift transmission gear D7 and the second output shaft OS2 are synchronization-connected through the fifth sleeve SLE of the fifth synchronizer SL5 for next forward 7-th shift transmission.

### [Forward 7-th Shift]

When the vehicle velocity increases in the state of the sixth shift and the driver intends to shift the sixth shift to the seventh shift, the first clutch CL1 is operation-controlled and the second sleeve SLE2 of the second synchronizer SL2 is controlled to neutral while the operation of the second clutch CL2 is released in the state of the sixth shift.

Then, while the seventh-shift transmission gear D7 and the second output shaft OS2 are synchronization-connected through the fifth sleeve SLE5 of the fifth synchronizer SL5 as the preliminary operation in the forward 6-th shift state, the forward 7-th shift driving is performed while the rotary power of the engine ENG is transferred to the final reduction gear FSDG configured in the differential DIFF through the first clutch CL1, the first input shaft IS1, the sixth input gear G6, the seventh-shift transmission gear D7, the second output shaft OS2, and the second output gear OG2.

In addition, after the forward 7-th shift transmission is completed as described, the eighth-shift transmission gear D8 and the second output shaft OS2 are synchronization-connected through the fourth sleeve SLE4 of the fourth synchronizer SL4 for next forward 8-th shift transmission.

### [Forward 8-th Shift]

When the vehicle velocity increases in the state of the seventh shift and the driver intends to shift the seventh shift to the eighth shift, the second clutch CL2 is operation-controlled and the fifth sleeve SLE5 of the fifth synchronizer SL5 is controlled to neutral while the operation of the first clutch CL1 is released in the state of the seventh shift.

Then, while the eighth-shift transmission gear D8 and the second output shaft OS2 are synchronization-connected through the fourth sleeve SLE4 of the fourth synchronizer SL4 as the preliminary operation in the forward 7-th shift state, the forward 8-th shift driving is performed while the rotary power of the engine ENG is transferred to the final reduction gear FSDG configured in the differential DIFF through the second clutch CL2, the second input shaft IS2, the third input gear G3, the eighth-shift transmission gear D8, the second output shaft OS2, and the second output gear OG2.

### [Reverse]

In the reverse shift step, the first output shaft OS1 and the reverse transmission gear R are synchronization-connected through the first sleeve SLE1 of the first synchronizer SL1 and the second clutch CL2 is operation-controlled.

Then, reverse driving is performed while the rotary power of the engine ENG is transferred to the final reduction gear FSDG configured in the differential DIFF through the second clutch CL2, the second input shaft IS2, the reverse input gear RG, the first reverse idle gear RIG1, the second reverse idle gear RIG2, the reverse transmission gear R the first output shaft OS1, and the first output gear OG1.

In describing such a shifting process, a case where sequential shifting to a higher shift step is performed is described as an example and in this case, when shifting is performed to any one shift step (forward 3-rd shift is assumed), an operation state of the synchronizer of a lower shift step (forward 2-nd shift) before shifting may be maintained or a synchronizer of the higher shift step (forward 4-th shift) for next shift may be preliminarily operated and this is to perform rapid and smooth shifting from a current shift step to a higher or lower shift step according to an operation condition of the vehicle.

Further, contrary thereto, when sequential shifting to the lower shift step is performed, the shifting may be performed in a reverse order thereto.

As described above, according to an exemplary embodiment of the present invention, in a transmission apparatus for a vehicle, which has two clutches based on a manual transmission, a pair of gear trains which externally engage with each other are disposed on an input shaft and two output shafts without a separate idle shaft for a reverse shift to implement a reverse shift step, and as a result, an upper whole length (a circumferential volume) of the transmission is minimized to enhance mountability in an engine room.

Further, n the power transmission apparatus for a vehicle according to the exemplary embodiment of the present invention, the idle shaft for the reverse shift is omitted, and as a result, a weight can be minimized and fuel efficiency can be enhanced due to a decrease in the number of components.

Further, n the power transmission apparatus for a vehicle according to the exemplary embodiment of the present invention, forward 8 shifts and reverse 1 shift are implemented to enhance the fuel efficiency through implementing multiple levels.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A power transmission apparatus for a vehicle, the power transmission apparatus comprising:
a power control unit constituted by first and second clutches configured at an output side of an engine to control rotary power of the engine;
an input unit configured by configuring a plurality of input gears on first and second input shafts overlapped and disposed on the same axis line without rotary interference so that the rotary power of the engine is input through the power control unit;
a shift output unit constituted by first and second output shafts that are disposed in parallel to the first and second input shafts, respectively, and in which a plurality of transmission gears externally engaging with respective input gears on the first and second input shafts is disposed, wherein a plurality of synchronization units are synchronization-connected to the plurality of transmission gears to the first and second output shafts, and wherein first and second output gears are configured on the first and second output shafts, respectively to externally engage with a final reduction gear of a differential; and
a reverse shift unit constituted by a reverse input gear configured in one input shaft of the first and second input shafts, a reverse transmission gear disposed on one output shaft of the first and second output shafts and synchronization-connected to one output shaft by the synchronization unit, and the reverse shift unit also constituted by a reverse idle gear unit disposed on the other output shaft without rotary interference, the reverse idle gear unit configured to decelerate and inversely rotate the rotary power of the reverse input gear and to transfer the rotary power to the reverse transmission gear to form a reverse shift step power transfer path.

2. The power transmission apparatus of claim 1, wherein the reverse idle gear unit comprises a first reverse idle gear disposed on the other output shaft without rotary interference and externally engaging with the reverse input gear.

3. The power transmission apparatus of claim 2, wherein the reverse idle gear unit further comprises a second reverse idle gear disposed on the other output shaft without rotary interference, formed integrally with the first reverse idle gear, and externally engaging with the reverse transmission gear.

4. The power transmission apparatus of claim 1, wherein one input shaft comprises a solid shaft and the other input shaft comprises a hollow shaft disposed at an outer periphery of the one input shaft.

5. The power transmission apparatus of claim 1, wherein the plurality of transmission gears comprises a first-shift transmission gear to an eighth-shift transmission gear.

6. The power transmission apparatus of claim 5, wherein the first-shift and six-shift transmission gears are configured in one synchronization unit.

7. A power transmission apparatus for a vehicle, the power transmission apparatus comprising:
a power control unit constituted by first and second clutches configured at an output side of an engine to control rotary power of the engine;
an input unit configured by configuring a plurality of input gears on first and second input shafts overlapped and disposed on the same axis line without rotary interference so that the rotary power of the engine is input through the power control unit;
a shift output unit constituted by first and second output shafts that are disposed in parallel to the first and second input shafts, respectively, and in which a plurality of transmission gears externally engaging with respective input gears on the first and second input shafts is disposed, wherein a plurality of synchronization units synchronization-connect the plurality of transmission gears to the first and second output shafts, and wherein first and second output gears are configured on the first and second output shafts, respectively to externally engage with a final reduction gear of a differential; and
a reverse shift unit constituted by a reverse input gear configured in the second input shaft, a reverse transmission gear disposed on the first output shaft and synchronization-connected to the first output shaft by the synchronization unit, and a reverse idle gear unit disposed on the second output shaft without rotary interference, the reverse idle gear unit configured to decelerate and inversely rotate the rotary power of the reverse input gear and to transfer the rotary power to the reverse transmission gear to form a reverse shift step power transfer path.

8. The power transmission apparatus of claim 7, wherein the first input shaft is configured by a solid shaft, a plurality of input gears is configured, and the rotary power of the engine is input through the first clutch.

9. The power transmission apparatus of claim 8, wherein the second input shaft is configured by a hollow shaft and is disposed at an outer periphery of the first input shaft to configure the plurality of input gears, and the rotary power of the engine is input through the second clutch.

10. The power transmission apparatus of claim 7, wherein the first input shaft comprises a solid shaft and the second input shaft comprises a hollow shaft disposed at an outer periphery of the first input shaft.

11. The power transmission apparatus of claim 7, wherein the reverse idle gear unit comprises a first reverse idle gear disposed on the second output shaft without rotary interference and externally engaging with the reverse input gear.

12. The power transmission apparatus of claim 11, wherein the reverse idle gear unit further comprises a second reverse idle gear disposed on the second output shaft without rotary interference, formed integrally with the first reverse idle gear, and externally engaging with the reverse transmission gear.

13. The power transmission apparatus of claim 12, wherein:
the first input shaft is configured by a solid shaft, a plurality of input gears is configured, and the rotary power of the engine is input through the first clutch; and
the second input shaft is configured by a hollow shaft and is disposed at an outer periphery of the first input shaft to configure the plurality of input gears, and the rotary power of the engine is input through the second clutch.

14. The power transmission apparatus of claim 12, wherein the first input shaft comprises a solid shaft and the second input shaft comprises a hollow shaft disposed at an outer periphery of the first input shaft.

15. The power transmission apparatus of claim 7, wherein the plurality of transmission gears comprises a first-shift transmission gear to an eighth-shift transmission gear.

16. The power transmission apparatus of claim 15, wherein the first-shift and six-shift transmission gears are configured in one synchronization unit.
